(19) United States
(12) Patent Application Publication
(10) Pub. No.: US 2002/0150007 A1
(43) Pub. Date: Oct. 17, 2002

(54) Apparatus for writing an optical record carrier

(76) Inventors: Yasumasa Watabe, Hasselt (BE); Jan Wijman, Hasselt (BE)

Correspondence Address: Philips Electronics North America Corp., 580 White Plains Road, Tarrytown, NY, 10591, US

(21) Appl. No.: 10/067,042

(22) Filed: Feb. 4, 2002

(30) Foreign Application Priority Data
Feb. 7, 2001 (EP) 01200437.0

(51) Int. Cl. G11B 7/125

(52) U.S. Cl. 369/44.36; 369/59.11; 369/53.27

(57) ABSTRACT

An apparatus for writing an optical record carrier (10) according to the invention comprises a write head (21) with a radiation source (22) and an optical system (23) for projecting a scanning spot (24) at the record carrier (10). The write unit (20) further comprises a first detector (25) for generating a first detection signal (Sd1) which is indicative for an intensity of the radiation source (22). It also comprises a second detector (26) for generating a second detection signal (Sd2) which is indicative for an amount of radiation reflected by the record carrier (10). The write unit (20) comprises a supply circuit (27) for modulating the intensity of the radiation source (22) between at least a first and a second value in response to a write signal (Sw). The apparatus according to the invention furthermore comprises a control circuit (30) for controlling the power of the radiation source. The control circuit (30) comprises a first feedback loop (25, 31, 32, 33) including the first detector (25) for generating a first control signal (Sc1) and a second feedback loop (25, 35, 36), including the second detector (25). A unit (35) generates a ratio signal (Sr) which is representative for the ratio between the amount of reflected radiation during writing and during erasing. The second feedback loop further comprises a signal combination unit (36) for generating a second control signal (Sc2) which is indicative for the product of the ratio signal (Sr) and the first control signal (Sc1).

The invention pertains to an apparatus for writing an optical record carrier, comprising:

a write unit for generating physically detectable patterns at the record carrier in response to a write signal which is modulated between at least a first and a second signal level, the write unit comprising a write head with a radiation source and an optical system for projecting a scanning spot at the record carrier, the write unit comprising a first detector for generating a first detection signal which is indicative for an intensity of the radiation source, and a second detector for generating a second detection signal which is indicative for an amount of radiation reflected by the record carrier, the write unit comprising a supply circuit for modulating the intensity of the radiation source between at least a first and a second value in response to the write signal,

a control circuit for setting the first and the second value,

displacement means for causing a relative displacement between the scanning spot and the record carrier.

From U.S. Pat. No. 4,796,267 a laser controller is known which comprises a negative feedback loop to control an average light quantity level despite variations in temperature. The feedback loop comprises a sensor for generating an output signal which is a measure for the power of radiation of the radiation source, a low-pass filter for low pass filtering the output signal. The feedback loop further comprises a subtractor for generating a difference signal which is a difference between said low-pass filtered signal and a setpoint signal representing the desired average light quantity level. The known circuit maintains the average light quantity level when the temperature changes. However, if the temperature changes also the proportionality factor between the control current and the light quantity level of the semiconductor radiation source changes. This implies that the difference between the output levels of the radiation source changes with a changing temperature.

Also control circuits are known which include feedback means which monitor the respective power of the radiation for each modulation level and adapt the control current accordingly. This has the disadvantage that the feedback means require a large bandwidth.

It is a purpose of the invention to provide an apparatus for writing a record carrier which is capable of maintaining a plurality of intensity levels at a predetermined value, using a feedback loop with a relatively low bandwidth. According to the invention the apparatus of the above described kind is characterized in that the control circuit comprises a first feedback loop for generating a first control signal, which feedback loop includes the first detector, the control circuit comprises a second feedback loop for generating a second control signal, the second feedback loop including the second detector and a unit for generating a ratio signal which is representative for the ratio between the amount of reflected radiation when the write signal assumes the first signal level and when it assumes the second signal level, the control circuit further comprising a signal combination unit for generating the second control signal, this signal being indicative for the product of the ratio signal and the first control signal.

In the apparatus according to the invention one of the levels is controlled by the first feedback loop which comprises the first detector. For this purpose a relatively slow feedback loop suffices. The ratio of the different levels is controlled by means of a the second feedback loop which uses the second detector for generating the second detection signal which is indicative for an amount of radiation reflected by the record carrier. Usually an apparatus for writing a record carrier is also suitable for reading a record carrier. Such an apparatus will already comprise a detector for measuring an amount of reflected radiation. In the device according to the invention a reliable control of the power of the radiation source is obtained by combining the output signals of the first and the second detector.

In the embodiment of claim 2 the erase level is retrieved from the first detection signal. This is advantageous because when using NRZ-modulation the erasure level is maintained at a constant value during a considerably longer time interval than the writing level. Hence, it is relatively easy to sample an accurate value of the erasure level.

The means for causing a relative displacement between the scanning spot and the record carrier comprise in the present embodiment a motor for rotating the record carrier, and means for radially displacing a read head. The means for radially displacing the head may e.g. comprise a slide or a swing arm. In addition said means may comprise fine displacement means, for example an actuator for displacing the scanning spot with respect to the head, for example by moving an optical element in the head, such as a mirror or a lens. In another embodiment the record carrier is a card. In that embodiment the head and the record carrier may be movable with respect to each other in mutually orthogonal directions, for example by linear motors.

These and other aspects of the invention are described in more detail with reference to the drawings. Therein:

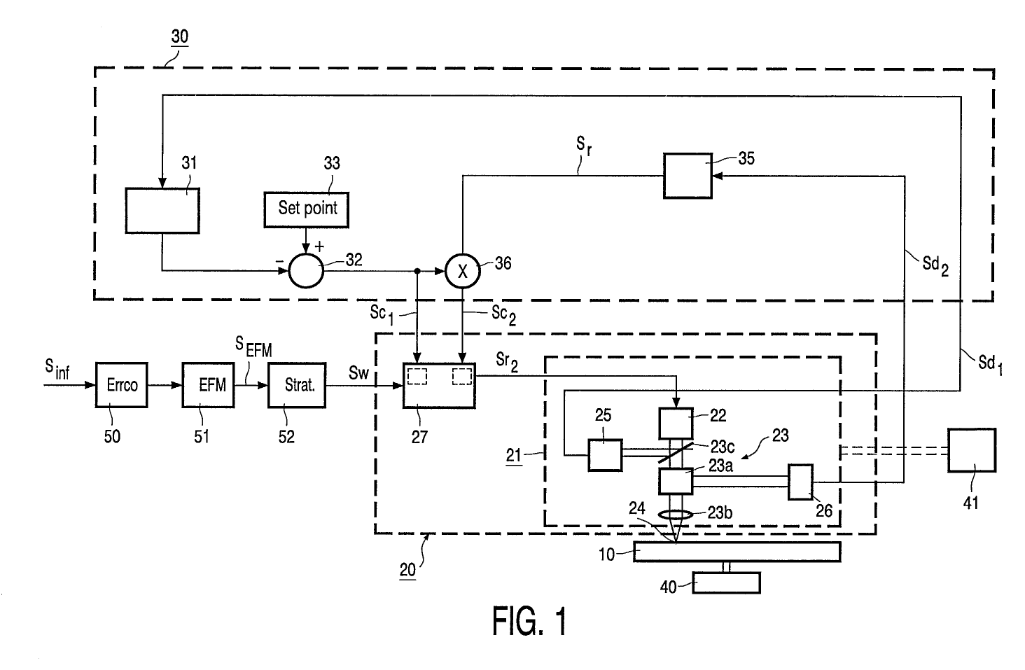

FIG. 1 schematically shows an apparatus for writing an optical record carrier,

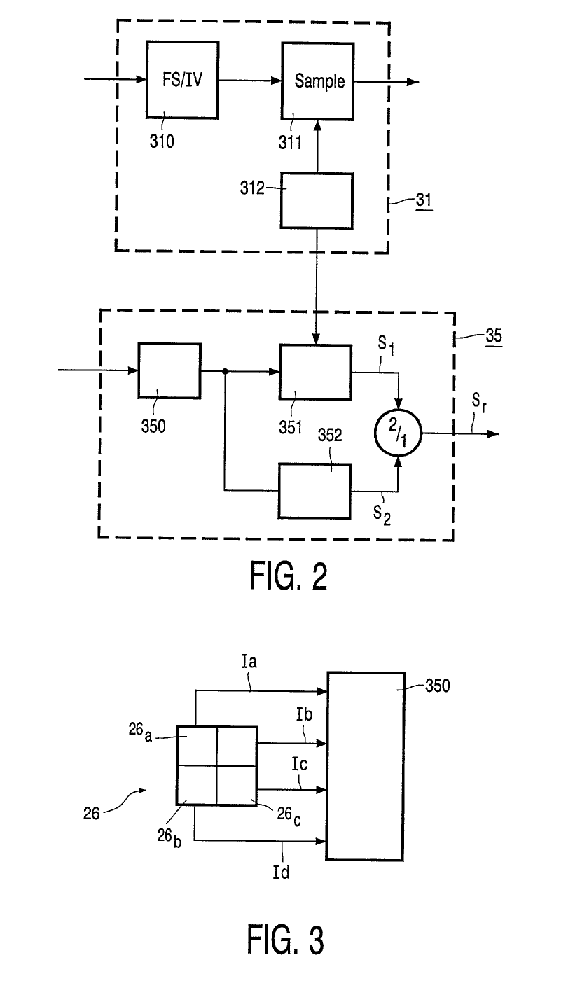

FIG. 2 shows a part of the apparatus of FIG. 1 in more detail,

FIG. 3 shows another part of the apparatus of FIG. 1 in more detail,

FIG. 4 gives a further detailed illustration of a part shown in FIG. 3.

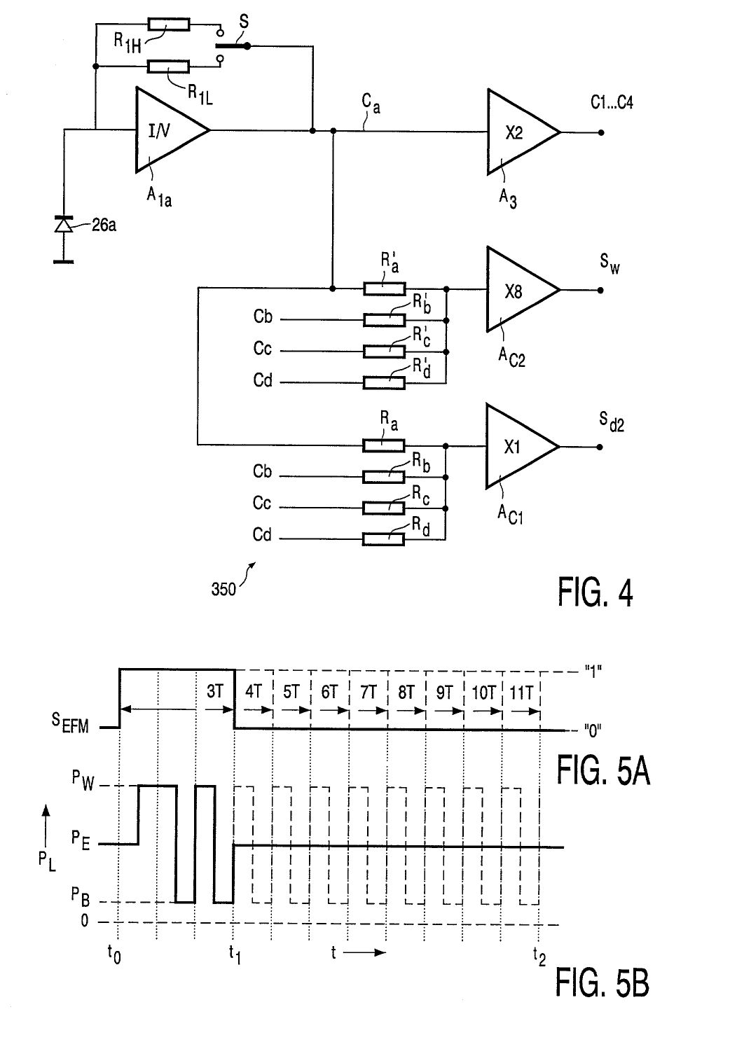

FIGS. 5A and 5B show respective signals in the apparatus according to the invention.

FIG. 1 schematically shows an apparatus for writing an optical record carrier 10. The apparatus shown therein comprises a write unit 20 for generating physically detectable patterns at the record carrier 10 in response to a write signal Sw which is modulated between at least a first and a second signal level. The write signal Sw is generated from an information signal Sinf by a chain of processing units comprising a first unit for applying an error-correction code (e.g.CIRC) to the information signal Sinf. The signal so obtained is applied to a channel encoding unit 51 (e.g. EFM or EFM+). The output signal of the channel encoder 51 is provided to a write strategy generator 52, which on its turn provides the write signal Sw.

The write unit 20 comprises a write head 21 with a radiation source 22, such as a semiconductor laser and an optical system 23 for projecting a scanning spot 24 at the record carrier 10. As schematically shown the optical system 23 comprises beam splitting element 23a, and a focussing lens 23b, but various other implementations are possible. The write unit 20 further comprises a first detector 25 for generating a first detection signal Sd1 which is indicative for an intensity of the radiation source 22. The first detector 25 receives a portion of the radiation emitted by the radiation source via a partial reflecting element 23c. The write unit 20 further comprises a second detector 26 for generating a second detection signal Sd2 which is indicative for an amount of radiation reflected by the record carrier 10. The second detector generates the second detection signal Sd2 in response to radiation which is reflected from the record carrier 10 via the beam splitting element 23a.

The write unit 20 further comprises a supply circuit 27 for modulating the intensity of the radiation source 22 between at least a first and a second value in response to the write signal Sw.

The apparatus further comprises a control circuit 30 for setting the first and the second value.

The apparatus shown comprises displacement means 40, 41 for causing a relative displacement between the scanning spot 24 and the record carrier 10. In the embodiment shown the displacement means comprise a spindle motor 40 for rotating the record carrier 10 and a slide motor 41 for sliding the write head 21 in a radial direction. The write head 21 also comprises a radial actuator (not shown) for precisely displacing the scanning spot over small distances. e.g. by radially moving the lens 23b and an axial actuator (not shown) for adjusting the focus of the scanning spot 24, e.g. by axially moving the lens 23b.

The apparatus is characterized in that the control circuit 30 comprises a first feedback loop 25, 31,32, 33 for generating a first control signal Sc1. The first feedback loop includes the first detector 25. The output signal Sd of the detector is sent via signal processing unit 31 to a comparison unit 32. The latter unit 32 compares the output signal of the signal processing unit 31 with a set point generated by setpoint generator 33. The output of the comparison unit 32 serves as the first control signal. The control circuit 30 further comprises a second feedback loop 25, 35, 36 for generating the second control signal Sc2. The second feedback loop includes the second detector 25, and a unit 35 for generating a ratio signal Sr which is representative for the ratio between the amount of reflected radiation when the write signal assumes the first signal level and when it assumes the second signal level. The control circuit 30 further comprising a signal combination unit 36 in the second loop for generating the second control signal Sc2. This signal is indicative for the product of the ratio signal Sr and the first control signal Sc1.

As shown in FIG. 2, the signal processing unit 31 of the first feedback loop includes a current to voltage converter 310 for converting the first detection signal from a current signal into a voltage signal. The signal processing unit also comprises a sample and hold unit 311 for sampling the, converted, first detection signal Sd1. The sample and hold unit 311 is coupled to a sample signal generator 312 which generates a sample signal at a moment that a portion of the record carrier 10 is erased. As the erase level is maintained during a substantially longer time interval said level can be accurately sampled despite the slow response of the first detector 25.

Also it can be seen in FIG. 2 that the unit 35 for generating a ratio signal Sr comprises a sample and hold unit 351 for sampling the second detection signal Sd2 and generating a first auxiliary signal S1. The sample and hold unit 351 is coupled to a sample signal generator 312 which generates a sample signal at a moment that a portion of the record carrier is to be erased. In this embodiment the first and the second feedback loop share the sample generator 312 shown in FIG. 2. The unit 35 further comprises a peak detector 352 for generating a second auxiliary signal S2. The peak detector 352 and the sample and hold unit 351 are coupled to a signal combination device 353 for generating the ratio signal Sr from the first S1 and the second auxiliary signal S2. The sample and hold unit 351 and the peak detector 352 receive the second detection signal via a signal processing unit 350, which may for example include current to voltage conversion means.

In the embodiment shown in FIG. 3 the second detector 26 comprises a plurality of detection elements 26a, . . . , 26d.

An embodiment of the signal processing unit 350 is shown in more detail in FIG. 4. In the embodiment of FIG. 4 the detection elements 26a are coupled via, variable gain input amplifiers A1a to a first common amplifier Ac1 and to a second common amplifier Ac2. For clarity purposes only one of the detection elements 26a and the input amplifier Ala coupled thereto is shown. The other detection elements 26b, 26c, 26d and the other input amplifiers are identical to the detection element 26a and the input amplifier Ala shown respectively. The apparatus according to the invention has a read mode and a write mode. In the write mode the variable gain amplifiers A1a, . . . have a relatively low amplification and the first common amplifier Ac1 provides the second detection signal Sd2. In the read mode the variable gain amplifiers have a relatively high amplification and the second common amplifier Ac2 provides a read signal Sw. The amplification of the variable gain amplifiers A1a, . . . is controlled by means of a switch S which selects either a first resistor R1L or a second resistor R1H as the feedback resistance. The output signals Ca, Cb, Cc, Cd of the input amplifiers A1a, . . . are coupled to the first common amplifier Ac1 via first resistive elements Ra, Rb, Rc, Rd. The output signals Ca, Cb, Cc, Cd of the input amplifiers A1a, . . . are coupled to the second common amplifier Ac2 via first resistive elements Ra′, Rb′, Rc′, Rd′.

As shown in FIG. 4 the variable gain amplifiers A1a, . . . are also coupled to third amplifiers A3. The latter provide servo signals for radial and axial control of the scanning spot. For clarity purposes only one of those third amplifiers A3, which is coupled to the input amplifier A1a is shown. The other amplifiers which amplify the signals Cb, Cc and Cd are identical thereto. The variable gain input amplifiers A1a make it possible to adapt the amplification to the different rages of power which are used by the radiation source 22 in different modes of the apparatus. In the read mode the output signals of the third amplifiers A3 have a relatively high gain, e.g. 8 mV/μW and in the write mode they have a relatively low gain e.g. 2 mV/μW. In this way reliable servo signals are obtained which are not clipped by the dynamic range of the signal processor 350 on the one hand during write mode and which do have an acceptable signal to noise ratio during the read mode.

The apparatus according to the invention operates as follows. An information signal Sinf received by the apparatus is encoded by applying an error-correction code (e.g.CIRC) to said information signal. Subsequently the encoded signal is applied to a channel encoding unit 51 (e.g. EFM or EFM+) so as to generate a channel encoded signal S_{EFM}, see FIG. 5A. In the present embodiment the channel encoded signal S_{EFM} is a runlength limited signal. In FIG. 5A the continuous line shows by way of example a run of value “1” having a length of three clock cycles (3T), which is followed by a run of value “0” having a length of eight cycles. The dashed lines show a run of value “1” having a length of 4T, etc. The runlength encoded signal can be represented at a recording layer of a phase change disc by a sequence of spots being in an amorph or crystalline phase. The amorph phase, having a relatively low reflectance, is obtained by heating a spot of the recording layer to a high temperature and immediately cooling it down. This can be realized by applying a laser power which is rapidly modulating between a low level P_{B} and a high level P_{W}, as is illustrated in FIG. 5B by the continuous line between time t0 and t1. The low level P_{B} may in practice be recording layer at a moderate level and more gradually cooling it down. This can be realized by applying a relatively constant, intermediate laser power P_{E}, as is illustrated by the continuous line in the time interval t1, t2. In this case the amorph phase and the crystalline phase respectively represents a “1” and a “0” in the channel encoded signal S_{EFM}. However the complementary representation may be used alternatively.

The required power levels P_{W}, P_{B} for writing a “1” and the level P_{E} for erasing (writing a “0”) depend on the specific material which is used for the recording layer of the optical record carrier. According to the CD-RW standard the ratio P_{W}/P_{E} should be within the range of 0.4 to 0.66. The proper ratio for a particular disc may be measured by a test recording. However preferably this information is stored at the disc itself.

As is clear from FIG. 5B, the laser power fluctuates relatively slowly when the disc is erased, i.e. when the recording layer is transformed in its crystalline phase. Hence the momentaneous value of the laser power can be measured relatively accurately even by a relatively slow detector. However during writing a “1” the laser power fluctuates relatively rapidly between a low level P_{B} and a high level P_{W}. The second detector provides a second detection signal Sd2 which is indicative for the power of the radiation reflected by the record carrier 10. From this signal Sd2 a first auxiliary signal S1 is derived which is indicative for the reflected power when the laser power has a value P_{E} by sampling the second detection signal Sd2 when a “0” is written at the record carrier. A second auxiliary signal S2 is derived which is indicative for the reflected power when the laser power has a value P_{W}. This signal S2 can easily be detected by using a maximum detector 352. Otherwise the second auxiliary signal S2 may be generated by sampling the second detection signal Sd2 at a time t*. From these two auxiliary signal S1, S2 the ratio signal Sr is derived which is representative for the ratio P_{W}/P_{E}. Even if the second detector 25 has a slow response time, the high level P_{W} of the laser power can be determined from the first control signal Sc1 and the ratio signal Sr by means of the combination unit 36. Hence both the erase level P_{E} during writing a “0” and the high level P_{W} of the laser power during writing a “1” can be controlled reliably.

It is remarked that the scope of protection of the invention is not restricted to the embodiments described herein. Neither is the scope of protection of the invention restricted by the reference numerals in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general purpose processor. The invention resides in each new feature or combination of features.

1. Apparatus for writing an optical record carrier (10), comprising
a write unit (20) for generating physically detectable patterns at the record carrier in response to a write signal (Sw) which is modulated between at least a first and a second signal level, the write unit (20) comprising a write head (21) with a radiation source (22) and an optical system (23) for projecting a scanning spot (24) at the record carrier (10), the write unit (20) comprising a first detector (25) for generating a first detection signal (Sd1) which is indicative for an intensity of the radiation source (22), and a second detector (26) for generating a second detection signal (Sd2) which is indicative for an amount of radiation reflected by the record carrier (10), the write unit (20) comprising a supply circuit (27) for modulating the intensity of the radiation source (22) between at least a first and a second value in response to the write signal (Sw),
a control circuit (30) for setting the first and the second value,
displacement means (40, 41) for causing a relative displacement between the scanning spot (24) and the record carrier (10), characterized in that the control circuit (30) comprises a first feedback loop (25, 31, 32, 33) for generating a first control signal (Sc1), which feedback loop includes the first detector (25), the control circuit (30) comprises a second feedback loop (25, 35, 36) for generating the second control signal (Sc2), the second feedback loop including the second detector (25), and a unit (35) for generating a ratio signal (Sr) which is representative for the ratio between the amount of reflected radiation when the write signal assumes the first signal level and when it assumes the second signal level, the control circuit (30) further comprising a signal combination unit (36) for generating the second control signal (Sc2), this signal being indicative for the product of the ratio signal (Sr) and the first control signal (Sc1).

2. Apparatus according to claim 1, characterized in that the first feedback loop comprises a sample and hold unit (311) for sampling the first detection signal (Sd1), the sample and hold unit (311) being coupled to a sample signal generator (312) which generates a sample signal at a moment that a portion of the record carrier is to be erased.

3. Apparatus according to claim 1 or 2, characterized in that the unit (35) for generating a ratio signal (Sr)comprises a sample and hold unit (351) for sampling the second detection signal (Sd2) and generating a first auxiliary signal (S1), the sample and hold unit (351) being coupled to a sample signal generator (312) which generates a sample signal at a moment that a portion of the record carrier is to be erased, the unit (35) further comprising a peak detector (352) for generating a second auxiliary signal (S2), the peak detector (352) and the sample and hold unit (351) being coupled to a signal combination device (353) for generating the ratio signal (Sr) from the first (S1) and the second auxiliary signal (S2).

4. Apparatus according to one of the claims 1 to 3, characterized in that the second detector (26) comprises a plurality of detection elements (26a, 26b, 26c, 26d).

5. Apparatus according to claim 4, characterized in that the detection elements (26a, 26b, 26c, 26d) are coupled via variable gain input amplifiers (A1a ) to a first and a second common amplifier (Ac1 and Ac2 resp.), the apparatus having a read mode and a write mode, wherein, in the write mode the variable gain amplifiers (A1a ) have a relatively low amplification and the first common amplifier (Ac1) provides the second detection signal (Sd2), and wherein, in the read mode the variable gain amplifiers (A1a ) have a relatively high amplification and the second common amplifier (Ac2) provides a read signal (Sw).

6. Apparatus according to claim 5, characterized in that the variable gain amplifiers (A1a ) are also coupled to third amplifiers (A3), which provide servo signals for radial and axial control of the scanning spot (24).
